(19) United States
(12) Patent Application Publication
(10) Pub. No.: US 2011/0005279 A1
(43) Pub. Date: Jan. 13, 2011

(54) LAUNDRY TREATING MACHINE AND CONTROL METHOD OF THE SAME

(76) Inventors: Hea Kyung Yoo, Seoul (KR); Sog Kie Hong, Seoul (KR); Dong Won Kim, Seoul (KR); Jong Seok Kim, Seoul (KR); Dae Yun Park, Seoul (KR)

Correspondence Address: MCKENNA LONG & ALDRIDGE LLP, 1900 K STREET, NW, WASHINGTON, DC, 20006, US

(21) Appl. No.: 12/920,010

(22) PCT Filed: Mar. 27, 2009
(86) PCT No.: PCT/KR09/01573

§ 371 Date: Aug. 27, 2010

(30) Foreign Application Priority Data
Apr. 1, 2008 (KR) 10-2008-0030396

(51) Int. Cl. B08B 3/12

(52) U.S. Cl. 68/5 C

(57) ABSTRACT

A laundry treating machine and a control method of the same are disclosed. The laundry treating machine includes a receiving room, a steam generator, a circulation duct, a water collecting part, and a water drainage tank. The control method includes a draining step, a water drainage tank state determining step, and an alarming step generating an alarm signal according to the information obtained in the water drainage tank state determining step. According to the present invention, even in case of using a separable water drainage tank to discharge water contaminated or condensed generated during the laundry treating, it may be determined whether the water drainage tank is absent or whether water inside the water drainage tank reaches a predetermined water level, using a water level sensor installed in other positions except in the water drainage tank, for the convenience sake.

### TECHNICAL FIELD

The present invention relates to a laundry treating machine and a control method of the same. More particularly, the present invention relates to a laundry treating machine comprising a separable water drainage box to drain contaminated water or condensed water generated in treating laundry by steam or hot air supplied to the laundry and a water level sensor capable of determining whether the water drainage box is absent or a water level of the water drainage box reaches a preset value, and a control method of the same.

### BACKGROUND ART

Laundry treating machines are electric appliances which treat clothes, cloth items and the like (hereinafter, laundry) received in a receiving room provided in a cabinet. Here, the term ‘treating laundry put in the receiving room’ means a series of processes of supplying air or hot air to the laundry received in the receiving room to remove unpleasant smell, wrinkles and humidity remaining on the laundry and to give satisfaction to a user who will wear the treated laundry.

For example, if the user puts on the same clothes more than once, unpleasant smell, wrinkles or humidity happens to remain on the clothes. Such the unpleasant smell of the clothes must give an unpleasant feeling to the user who will put on the clothes again. To remove them, the clothes might be washed every time. However, often washing of the clothes could shorten the wearable life of the clothes and could increase the maintenance cost.

There might be wrinkles even on the clothes which have been dried after washed. Such the wrinkled clothes cannot be wearable immediately and the user has to perform an additional ironing inconveniently.

To solve the above problems can be used the laundry treating machine capable of removing the unpleasant smell, wrinkles or humidity.

In such the laundry treating machine, moisture may be supplied and air, including hot air, may be ventilated to dry the moisturized laundry, to remove the unpleasant smell, wrinkles and humidity.

The unpleasant smell, wrinkles and humidity may be removed only by exposing the laundry to wind or hot air. At this time, the moisture may be supplied to the laundry to substantially maximize the removal effect.

If the moisture is supplied to the laundry received in the laundry treating machine, minute water elements are combined with smell elements remaining deep in fibrous tissues of the fabric and the water elements combined with the smell elements are separated and discharged from the laundry during the drying. In such the process, the unpleasant smell removed from the laundry.

Through the above processes, the unpleasant smell, the wrinkles and humidity may be removed from the clothes and thus the user can put on the clothes, feeling pleasant and fresh.

Such the laundry treating machine supplies moisture to the laundry and collects water condensed from the moisture supplied during the drying to drain the collected water.

Unlike in the conventional laundry treating machine, a lot of water is not required to supply the moisture to the laundry in the laundry treating machine and thus a water supply source supplying water to a water supply device may be a separable water supply tank.

If water drainage facilities are provided, it is possible to drain the condensed water generated during the laundry treating process directly. If then, the relating installation would be complex and the direct drainage would be inefficient because the amount of the condensed water which will be drained is not so much.

If a separable water drainage tank is provided in the laundry treating machine, it is possible to empty the water drainage tank periodically.

### DISCLOSURE OF INVENTION

### Technical Problem

However, the case of draining the contaminated water or water condensed from the moisture may have following problems.

If the condensed water or contaminated water generated in the laundry treating machine is collected in the separable water drainage tank, water of more than a predetermined amount would be collected and the water inside the water drainage tank, which should have been drained outside, might be overflowed with repeated collecting of condensed or contaminated water.

In addition, it is not easy to install a water level sensor within the water drainage tank, because the water drainage tank is separable from the laundry treating machine.

The water sensor used a lot conventionally includes a plurality of electrodes and it measures a water level based on whether electric currents are applied to the electrodes. As a result, it could be inappropriate to install the electrodes in the water drainage tank which might have water overflow.

Accordingly, a method is demanded in that water level changes are sensed inside a separable water drainage tank having a predetermined capacity to determine a water drainage timing of the water drainage tank and to inform a user that the water drainage tank should be emptied.

In addition, a method is demanded that it is identified whether the separable water drainage tank is positioned at a right position, that is, whether the water drainage tank which is difficult to install the electrodes in is absent.

### Technical Solution

To solve the problems, an object of the present invention is to provide a to a laundry treating machine comprising a separable water drainage box to drain contaminated water or condensed water generated in treating laundry by steam or hot air supplied to the laundry and a water level sensor capable of determining whether the water drainage box is absent or a water level of the water drainage box reaches a preset value, and a control method of the same.

To achieve these objects and other advantages and in accordance with the purpose of the invention, as embodied and broadly described herein, a laundry treating machine includes a receiving room receiving laundry; a steam generator supplying steam to the receiving room; a circulation duct circulating air inside the receiving room; a water collecting part collecting water remaining or condensed from steam in the steam generator, the water collecting part capable of sensing a level of the collected water; and a water drainage tank receiving the water collected in the water collecting part and transferring the water received over a predetermined water level back to the water collecting part, the water drainage tank being separable.

The water received in the water drainage tank over a predetermined water level may be transferred to the water collecting part through a return hole formed on the water drainage tank.

A water overflow receiving room temporarily receiving the water transferred to the water collecting part may be provided between the water drainage tank and the water collecting part.

The water overflow receiving room may be provided under the water drainage tank.

The laundry treating machine may further include a water overflow receiving room configured of a separate water receiving tank receiving water overflowed through the return hole.

The return hole of the water drainage tank may be formed on a side of the water drainage tank.

The water collecting part may include a water level sensor sensing a water level based on whether an electric current is applied to electrodes installed therein and a drainage pump draining the water inside the water collecting part into the water drainage tank.

The drainage pump may drain the water inside the water collecting part into the water drainage tank and the water level sensor senses the water transferred to the water drainage tank from the water collecting part to measure a time interval between the drainage time point and the transfer time point.

An alarm signal alarming absence of the water drainage tank or alarming necessity of water draining of the water drainage tank may be generated, corresponding to the time interval.

The measuring the time interval may be performed if a power signal of the laundry treating machine is inputted.

The water inside the water collecting part may be transferred to the water drainage tank if it is sensed that water flow into the water collecting part, and an alarm signal alarming the necessity of the water draining of the water drainage tank if the water level inside the water collection part is continuously increased.

In another aspect, a control method of a laundry treating machine including a water collecting part collecting water remaining or condensed from steam generated to treat laundry, the water collecting part capable of sensing a level of the collected water, the control method includes a draining step draining a predetermined amount of water into a water drainage tank from the water collecting part, the water drainage tank being separable; a water drainage tank state determining step determining whether the water drained in the draining step is transferred to the water collecting part or how long the water transfer takes after the draining; and an alarming step generating an alarm signal according to the information obtained in the water drainage tank state determining step.

If it is determined that the water is transferred to the water collecting part, it may be determined whether the water drainage tank is absent or whether the water inside the water drainage tank reaches a preset water level based on the time taken for the water transfer after the draining.

The drain tank state judging step may compare the time taken to transfer the water drained in the draining step into the water collecting part with a preset time, to determine that the water drainage tank is absent if the time is shorter than the preset time and to determine that the water inside the water drainage tank reaches the preset water level if the time is longer than the preset time.

The alarming step may generate a signal identifying that the water drainage tank is absent or the water level inside the drain tank reaches the preset value.

### ADVANTAGEOUS EFFECTS

The present invention has following advantageous effects.

According to the laundry treating machine and the control method of the same, laundry is received in the laundry treating machine and steam or hot air is supplied to the laundry to remove wrinkles, unpleasant smell or humidity remaining on the laundry, in order to provide a user with a pleasant and fresh feeling.

Furthermore, even in case of using a separable water drainage tank to discharge water contaminated or condensed generated during the laundry treating, it may be determined whether the water drainage tank is absent or whether water inside the water drainage tank reaches a predetermined water level, using a water level sensor installed in other positions except in the water drainage tank, for the convenience sake.

### BRIEF DESCRIPTION OF DRAWINGS

The accompanying drawings, which are included to provide further understanding of the disclosure and are incorporated in and constitute a part of this application, illustrate embodiments of the disclosure and together with the description serve to explain the principle of the disclosure.

In the drawings:

FIG. 1 is a perspective view illustrating a laundry treating machine according to an exemplary embodiment;

FIG. 2 is a diagram schematically illustrating an inner structure of a mechanism room provided in the laundry treating machine;

FIG. 3 is a conceptual diagram illustrating a path of water or steam of the laundry treating machine;

FIG. 4 is a diagram illustrating an embodiment of a water overflow receiving room receiving water overflowed from a water drainage tank if water is overflowed from a water drainage tank receiving water more than a predetermined water level;

FIG. 5 is a diagram simply illustrating connection between the water drainage tank of FIG. 4 and a water collecting part;

FIG. 6 is diagram illustrating another embodiment of a water overflow receiving room receiving water overflowed from the water drainage tank having water more than a predetermined water level;

FIG. 7 is a diagram illustrating another embodiment of a water drainage tank and a water collecting part provided in the laundry treating machine; and

FIG. 8 is diagram illustrating a still further embodiment of a water collecting part.

### BEST MODE FOR CARRYING OUT THE INVENTION

Reference will now be made in detail to the specific embodiments of the present invention, examples of which are illustrated in the accompanying drawings. Wherever possible, the same reference numbers will be used throughout the drawings to refer to the same or like parts.

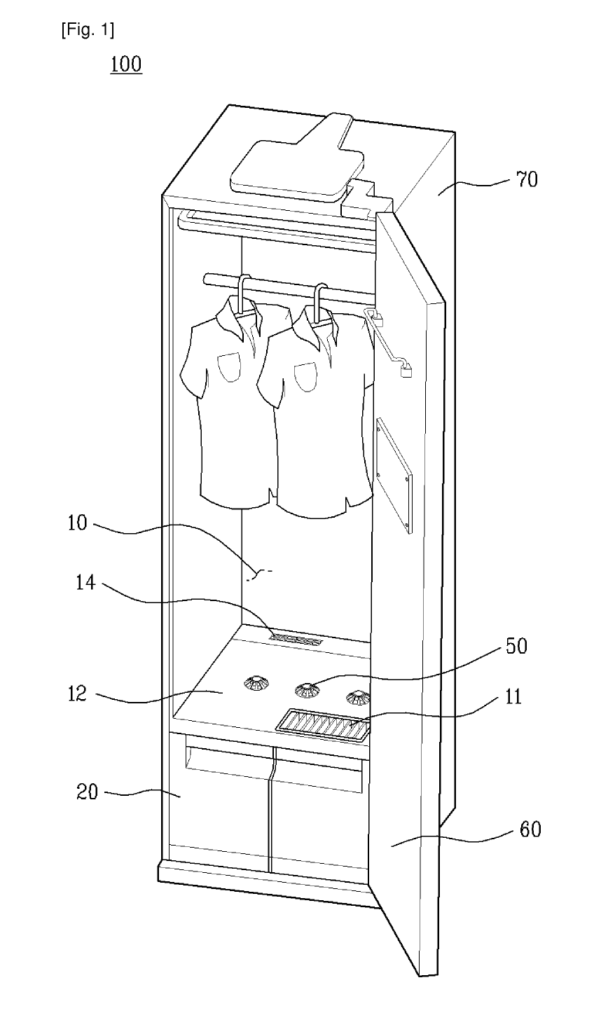

As shown in FIG. 1, a laundry treating machine 100 according to an exemplary embodiment includes a receiving room 10 which receives laundry and a mechanism room 20 provided under the receiving room 10. In the mechanism room 20 may be mounted various parts to circulate, dehumidify or heat air inside the receiving room 10, in order to remove unpleasant smell, wrinkles and humidity remaining on the laundry.

The receiving room 10 and the mechanism room 20 may be provided in a single cabinet 170.

The mechanism room 20 draws inner air of the receiving room 10 and re-supplies the air to the receiving room 10. At a bottom 12 of the receiving room 10 may be provided an inlet 11 through which the inner air of the receiving room 10 is drawn into the mechanism room and an outlet 14 through which the air is re-supplied to the receiving room 10.

The reason why the inlet 11 and the outlet 14 are provided at the bottom of the receiving room 10 is that the mechanism room 20 is provided under the receiving room 10.

The laundry treating machine may further include a moisture supply device supplying moisture to the receiving room 10 receiving the laundry. The moisture supply device supplying moisture to the laundry received in the receiving room 10 may be a moisture supplying device supplying moisture, for example, sprayed water or steam generated by heating water. That is, the moisture supplying device may be any types only capable of supplying moisture to the laundry received in the receiving room 10 uniformly.

From now on, a steam generator will be exemplified as the moisture supplying device and the steam generator generates steam which will be supplied to the receiving room.

A steam spraying unit 50 is provided in the receiving room 10 to spray steam generated by a steam generator provided in the mechanism room 20.

It is preferable that the inlet 11 and the outlet 14 have a net-shaped structure to prevent external foreign substances having a size larger than predetermined from being inserted therein.

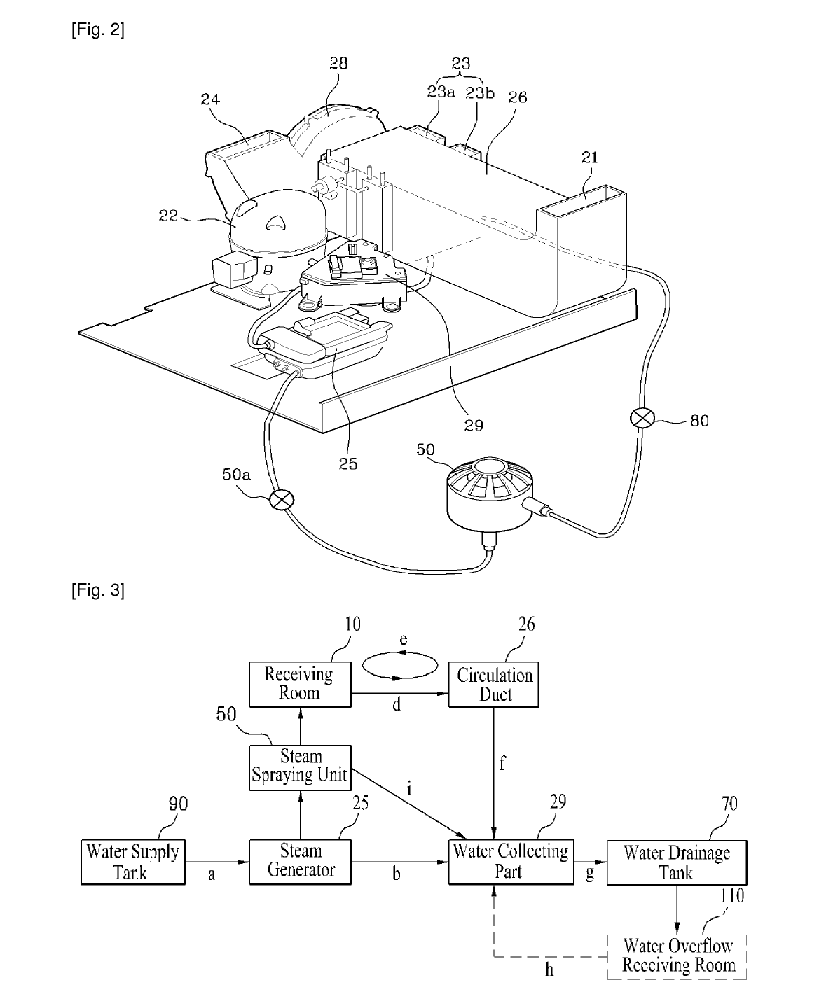

FIG. 2 illustrates the inner structure of the mechanism room 20 of the laundry treating machine according to the exemplary embodiment.

Here, a water supply tank or a water drainage tank provided separably in the mechanism room 20 shown in FIG. 2 will be described later.

In the mechanism room 20 may be provided a steam generator 25 and a circulation duct 26. The steam generator 26 generates the steam which will be supplied to the receiving room receiving the laundry. The circulation duct 26 draws humid air inside the receiving room 10 to dehumidify or heat.

The inlet 11 shown in FIG. 1 is in communication with an inlet hole 21 of the circulation duct 26 shown in FIG. 2 and the outlet 14 shown in FIG. 1 is in communication with an outlet hole 24 of the ventilation duct 28 shown in FIG. 2.

The circulation duct 26 may be categorized, based on a method of heating dehumidified air, into a heat pump type and an electric heater type.

If a heat pump or electric heater is used as means of heating the air which will be resupplied to the receiving room 10, the moisture of humid air drawn via the inlet hole 21 from the receiving room 10 is condensed and the air is dehumidified in both cases of using the heat pump and the electric heater. Here, if the heat pump is provided as means of heating air which will be re-supplied to the receiving room 10, a compressor and a heat exchanger may be further provided.

Of course, the circulation duct 26 has a ventilation function to simply circulate not-heated air. Such the ventilation function is functioned by a ventilation duct 28 including a fan to discharge the air having passed the circulation duct 26 via the outlet 14.

As shown in FIG. 2, if the heat pump is provided to heat the dehumidified air, a condensing part 23b and a heating part 23a may be provided. In the condensing part 23b, refrigerant compressed by the compressor 22 provided in the circulation duct 26 is evaporated to dehumidify the humid air. In the heating part 23a, the refrigerant is condensed to heat the dehumidified air.

If the heat pump is used to dehumidify and heat the humid air, an auxiliary electric heater may be provided to heat the dehumidified air sufficiently.

At this time, a laundry treating machine having a drying function may be categorized based on a drying method into a condensation, in other words, circulation type and an exhaustion type.

Specifically, the air is re-supplied to the receiving room 10 in the condensation or circulation type and the air is exhausted outside in the exhaustion type, after humid air inside the receiving room 10 is sucked and dehumidified. The laundry treating machine according to the exemplary embodiment adapts the circulation type capable of dehumidifying the air inside the receiving room 10, with circulating. The present specification will explain such the circulation type laundry treating machine.

The ventilation duct 28 may include an outlet hole 24 formed at an end thereof, in communication hole 14 of the receiving room 10, and an inlet hole 21 formed at the other opposite end thereof, in communication with the inlet 11 of the receiving room 10.

The air sucked via the inlet hole 21 is dehumidified at the condensation part 23b provided in the circulation duct 26 and then heated in the heating part 23a. If then, the air is re-supplied to the receiving room 10 via the ventilation duct 28.

The heat exchanger 23 of the laundry treating machine according to the exemplary embodiment dehumidifies humid air circulated in the receiving room 10, using refrigerant supplied from the compressor 22 in a refrigerant evaporation process and also the heat exchanger 23 re-heats the air dehumidified in a refrigerant condensation process.

It is necessary to compress the refrigerant between such the refrigerant evaporation and the refrigerant condensation. The compression of refrigerant is performed by the compressor 22 provided in the mechanism room 20.

In the mechanism room 20 shown in FIG. 2 may be provided a water drainage box 70 which is separable. The water condensed at the heat exchanger 23 is temporarily collected in a water collecting part 29 positioned under the heat exchanger 23 and the contaminated water collected in the water collecting part 29 is flowing into the water drainage box 70 to be stored.

The steam supplied to the laundry may be condensed in the receiving room and water condensed from the steam may be generated. As a result, the condensed water inside the receiving room is also drained into the water drainage tank separably installed in the mechanism room 20. However, the direct draining of the water inside the receiving room may make complex pipes provided in the mechanism room 20. It is efficient to drain the water the condensed water of the receiving room into a water collecting part 29 after bypassing the condensed water into a condensed water receiving room (not shown) provided in under the heat exchanger 23 of the circulation duct 26.

At this time, it also possible to directly drain the water into the water collecting part, without passing the circulation duct 26.

The water collecting part 29 not only collects the water condensed from the heat exchanger within the circulation duct 26 but also temporarily collects the water condensed from the receiving room 10 or water remaining in the steam generator 25 before flowing into the water drainage box 70.

Considering a capacity of the water drainage box 70, a user of the laundry treating machine may selectively separate the water drainage box 70 from the mechanism room 20 to throw out the contaminated water inside the water drainage box 70. A water drainage pump 27 may be used to move the condensed or contaminated water to the water drainage box 70 from the water collecting part 29.

If it is possible to install the water drainage box 70 under the heat exchanger 23, the water collecting part 29 may be omitted. However, to make the water drainage box 70 separable from the mechanism room 20, the water drainage box may be provided in an upper portion of the mechanism room 20, with using a pump.

That is, for the user to separate the water drainage box 70 from the mechanism room 20 smoothly, it is advantageous to install the water drainage box 70 in the upper portion of the mechanism room 20. As a result, it is necessary for the pump to compensate the height difference.

If the condensed or contaminated water is collected in the water collecting part 29 temporarily and then the collected water is drained into the water drainage tank 70 by a single drainage pump, there may be an advantage that the water can be drained at a time by the single pump.

The single water drainage pump can make the water drained into the water drainage tank collectively, if the condensed or contaminated water inside the circulation duct 23 or the receiving room is directly or indirectly collected in the water collecting part.

If they are separable, the water drainage box 70 and a water supply box 90, which will be described later, may be configured to be movable or rotatable from the mechanism room, with being installed to a drawer (not shown) movable forward and rearward or hingedly rotatable.

The contaminated water is moved to the water drainage box 70 from the water collecting part 29, using the water drain pump, and thus the size of the water collecting part 29 may be substantially smaller than that of the water drainage box 70.

The steam generator 25 provided in the mechanism room 20 heats water supplied from the water supply box 90 provided in the mechanism room 20 to generate steam which will be supplied to the receiving room 10.

The water supply box 90 may be a water containing box type which is separable from the mechanism room 20 like the water drainage box 90 shown in FIG. 2.

The separable water supply box 90 is used because the amount of water required to generate steam is substantially not so much and because the laundry treating machine should be installable in a place without water drainage facilities. Of course, if water drainage facilities are installed nearby, the water supply box 90 may be directly connected with the water drainage facilities.

The water supply box 90 supplies water to the steam generator 25 and the steam generated by the steam generator 25 is sprayed via the steam spraying unit.

According to the embodiment shown in FIG. 2, the steam spraying unit includes a first spraying unit 50 spraying steam into the receiving room 10 and a second steam spraying unit 55 spraying steam into the circulation duct 26.

FIG. 1 shows that the plurality of the first steam spraying units 50 are installed at the bottom 12 of the receiving room 10. However, it is premised in FIG. 2 that a single first steam spraying unit 50 is installed for convenience' sake.

The first steam spraying unit 50 is functioned to spray the steam received from the steam generator into the receiving room 10.

The circulation duct 26 is an air circulation path to suck and dehumidify or heat the air inside the receiving room 10.

A fan 28a provided in the ventilation duct 28 adjacent to the circulation duct 26 makes the circulation duct 26 suck and discharge air inside the receiving room.

The air inside the receiving room is drawn via the inlet hole 21 in communication with the inlet 11 of the receiving room 10 and the air passes the heat exchanger 23. If then, the air having passed the heat exchanger 23 is re-supplied to the receiving room 10 via the outlet 14 of the receiving room 10 in communication with the outlet hole 24.

As a result, the steam may be supplied in front of the heat exchanger for the condensation part 23b of the heat exchanger 23 to suck the supplied steam.

The steam generation method of the steam generator 25 presented in this embodiment is that a predetermined amount of water held in a water tank is heated by a heater in order to generate steam. However, any devices capable of generating steam may be applicable to this embodiment. For example, a heater may be directly installed around a water supply hose, in other words, water is not accommodated in a predetermined space to be heated.

If the remaining water is drained into the water drainage box 70, the water may be drained after being collected in the water collecting part 29.

The steam generator 25 sprays steam into the receiving room 10 receiving the laundry via the steam spraying unit 50.

For the water condensed from the steam to be directly drained into the water drainage box 70, the water condensed from the steam may be directly supplied to the water collecting part 29 or to the inside of the circulation duct 26 connected with the water collecting part 29.

In the latter case, the water condensed from the steam together with the water condensed at the condensation part 23b may be drained into the water drainage box 70 via the water collecting part 29. At this time, the structure may be simple, considering the length of pipes to connect relating parts.

The condensed water within the steam spraying unit 50 may be drained immediately when being generated. Here, it is preferable that the condensed water is remaining in the steam spraying unit for a predetermined time period to be gasified, because the water condensed from the steam is high temperature.

In addition, if the condensed water is remaining, the inner space of the steam spraying unit 50 is reduced enough to spray the supplied steam smoothly. Also, the high temperature condensed water can keep the steam warm.

For that, it is also preferable that a remaining valve 80 is provided between the steam spraying unit 50 and the water collecting part 29.

This it because the valve can stop the condensed water from being drained via a condensed water outlet hole 53 simultaneously when the condensed water is generated. The valve 80 may be an electric valve controlled by a control part (not shown) of the laundry treating machine.

According to this embodiment, the water condensed in the steam spraying unit 50 passes the water collecting part 29, not directly drained into the water drainage tank. If the condensed water is drained by the drainage pump after collected in the water collecting part 29 temporarily, the water condensed in the steam spraying unit 50 can be drained together with the water condensed in the heat exchanger 23 simply at a time.

The water collecting part 29 of the laundry treating machine according to the embodiment includes a water level sensor capable of measuring the amount of water condensed or contaminated therein.

The reason why the water collecting part 29 includes the water level sensor is that it is difficult to install a water level sensor in the separable water drainage tank and thus that the amount of condensed or contaminated water collected in the water collecting part 29 should be measured. A method of indirectly measuring a water level inside the water drainage tank by measuring a water level inside the water collecting part will be described in detail later.

FIG. 3 is a conceptual view illustrating a path of water or steam of the laundry treating machine.

The water supply tank 90 parable from the mechanism room supplies water to the steam generator 25 along a path ‘a’. On the path ‘a’ may be provided a water supply pump or a control valve to supply water to the steam generator 25 selectively.

If there is no height difference between the steam generator 25 and the water supply tank 90 or it is impossible to supply water by using the water pressure, the water supply pump is provided on the path ‘a’.

The steam generator 25 generates steam and sprays the steam into the receiving room 10 via the steam spraying unit 50 provided in the receiving room 10. Here, the water condensed within the steam spraying unit 50 is collected in the water collecting part 29 along a path ‘i’.

On the path ‘I’ may be provided a control valve (80, see FIG. 2) to drain the water condensed inside the steam spraying unit 50 selectively.

The condensed water of the steam spraying unit 50 may not be directly connected with water collecting part 29 and it may be drained into the water collecting part 29 via a condensed water receiving room provided in the circulation duct 26.

At this time, the steam supplied to the receiving room 10 may be used to treat the laundry. Humid air inside the receiving room 10 is circulated into the circulation duct 26 along a path ‘e’.

The condensed water inside the receiving room 10 may be drained into a condensed water receiving room inside the circulation duct 26, for example, a receiving room below the heat exchanger 23 inside the circulation duct 26 along a path ‘d’. In this case also, the water may be drained into the water collecting part 70 directly.

The air circulated in the circulation duct 26 is condensed in a condensation part (23b, see FIG. 2) of the heat exchanger 23 provided in the housing, where humid air is circulated and dehumidified, and the condensed water is received under the condensation part 23b. The condensed water received under the housing of the circulation duct 26 and the received water may be transferred into the water collecting part 29 along a path ‘f’.

As shown in FIG. 3, the water collecting part may be used as the space temporarily receiving the water contaminated or condensed in the receiving room 10, the circulation duct 26, the steam spraying unit 50 and the steam generator 26.

The water collecting part 29 as mentioned above may include the water level sensor and the drainage pump. The condensed or contaminated water collected in the water collecting part 29 may be drained into the water drainage tank 70 by the drainage pump.

In this case, the water may be drained from the water collecting part 29 into the water drainage tank 70 along a path ‘g’ which is a path of the forcible water drainage performed by the drainage pump.

The water drainage tank according to the exemplary embodiment has following characteristics. Although the water collected in the water collecting part 29 is drained into the water drainage tank 70, the water over a predetermined level is transferred to the water collecting part again along a path ‘h’.

If then, a water overflow receiving room 110 may be provided against the overflow of water stored in the water drainage tank 70 over a predetermined water level.

Specifically, if the water is drained into the water drainage tank over a predetermined water level, the water over the predetermined level is transferred to the water collecting part 29 again.

Since the water drainage tank 70 is separable not to measure the water level stored therein, the water collecting part 29 is used to determine the water draining timing of the water drainage tank.

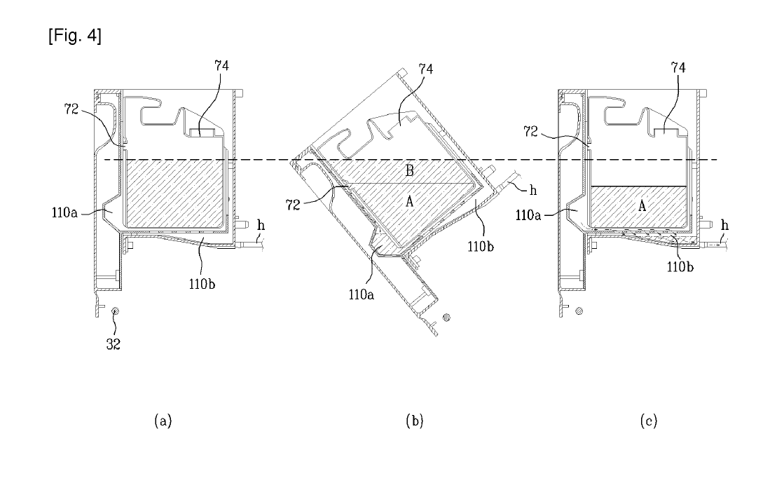

FIG. 4 illustrates an example of the water overflow receiving room 110 receiving the water overflowed from the water drainage tank 70 if the water level of the water drainage tank is over a predetermined value.

The water drainage tank 70 may be mounted to the door 30 coupled to the front of the mechanism room. If then, the water drainage tank 70 is mounded in the door 30 extractable in a forward and rearward direction as a drawer type or it may be mounted in the door 30 which is rotatable hingedly.

The structure of the latter case may be applied to the door. A return hole 72 is formed at a side of the water drainage tank 70, facing the door 30, and a draining hole 74 is formed at a top of the water drainage tank 70 to introduce the condensed or contaminated water drained from the water collecting part.

The size of the water drainage tank 70 is typically larger than that of the water supply tank 90 supplying water to the steam generator. If the water is preserved inside the water supply tank 90 for a relatively long time, foreign substances might be generated enough to deteriorate the water and then to damage the heater. As a result, it is preferable that the water drainage tank is filled up with fresh water before put into operation.

If the door 30 is rotated about a hinge shaft 32, the water inside the water drainage tank 70 is flowed through the return hole 72.

FIG. 4(a) illustrates a state that the water over the predetermined level is stored in the water drainage tank 70. FIG. 4(b) illustrates a state that the door 30 is rotated, with the water remaining above the return hole 72 is flowed through the return hole 72.

The water flowed through the return hole 72 is temporarily received in the water overflow receiving room 110 provided in an inner, side or lower portion of the door 30. Specifically, according to the example shown in FIG. 4, the water overflow receiving room 110 includes a first water overflow receiving room 110a provided at a rear surface of the door and a second water overflow receiving room 110b provided under the water drainage tank 70.

The water overflow receiving rooms 110a and 110b may be in communication with each other. The water overflowed through the return hole 72 is stored in the first water overflow receiving room 110a first and the water is transferred to the second water overflow receiving room 110b.

The water of the second water overflow receiving room 110b may be transferred into the water drainage tank 29 along a path ‘h’ shown in FIG. 3.

FIG. 4(c) illustrates that the water is remaining only in an oblique line area ‘A’ after the water over the predetermined water level inside the water drainage tank 70 is flowed into the water overflow receiving rooms 110a and 110b. That is, the amount of the water overflowed into the water overflow receiving rooms 110 and 110b is corresponding to an oblique line area ‘B’.

Thus, as shown in FIG. 4(c), although the door 30 is rotated, the water except the water corresponding to the slashed line area ‘A’ shown in FIG. 4(c) is transferred to the water overflow receiving rooms 110a and 110b or the water collecting part 29.

The appearance of the water overflow receiving rooms 110a and 110b may be any types capable of draining the water inside the water drainage tank if the water level of the water drainage tank 70 is over a predetermined value. according to the embodiment shown in FIG. 4, the water drainage tank 70 is coupled to the door 30 hingedly rotatable such that the water over the level of the slashed line area ‘A’ shown in FIG. 4(c) is drained into the water overflow receiving rooms 110a and 110b which will receive the water overflow temporarily.

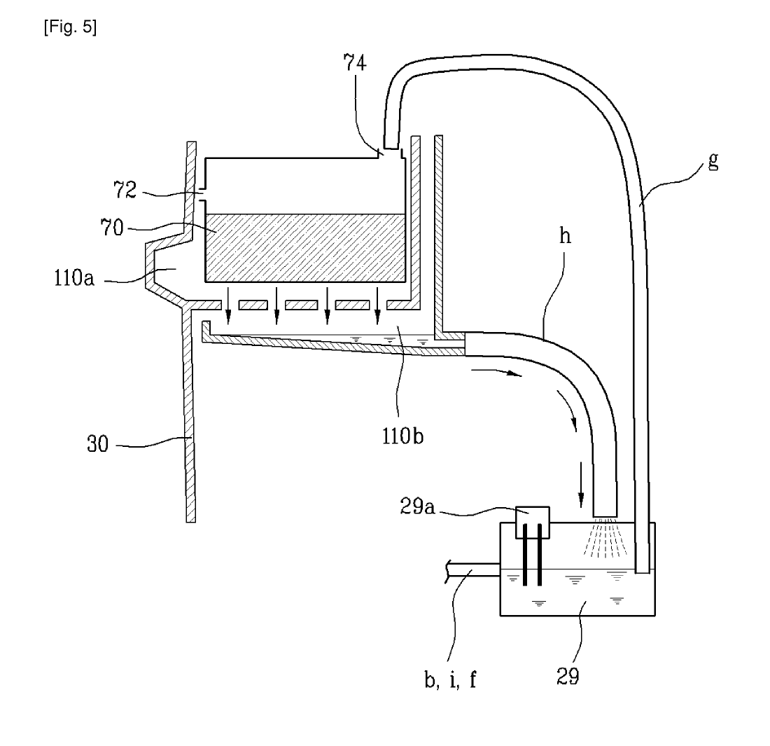

FIG. 5 illustrates the connection between the water drainage tank and the water collecting part shown in FIG. 4. The water collected in the water collecting part 29 may be drained into the water drainage tank 70 along a path ‘g’. The water collecting part 29 receives the contaminated or condensed water supplied by the receiving room 10 or the circulation duct 26 via the paths ‘b’, T and ‘f’.

The drainage signal generation based on the water level measurement at the water collecting part 29 will be described together with another example of a water overflow receiving room.

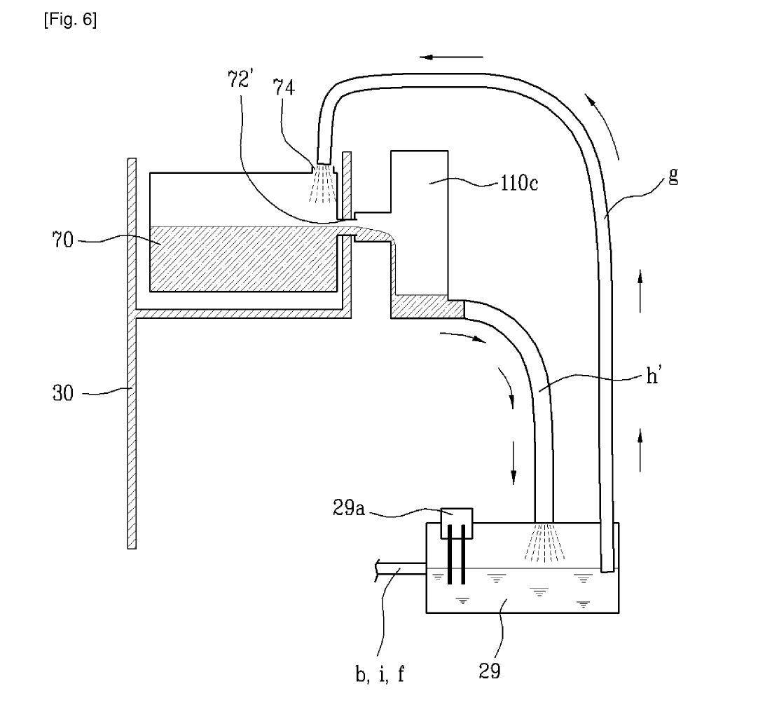

FIG. 6 illustrates another example of the water overflow receiving room 110 receiving the water over a predetermined water level. According to the embodiment shown in FIG. 6, the water overflow receiving room is a water overflow receiving tank 110c in communication with the water drainage tank 70. Here, the return hole 72′ is formed at a side surface of the water drainage tank 70 toward the inside of the mechanism room 20.

The water over the predetermined level with respect to the return hole 72′ passes the water overflow receiving room 110c in communication with the water drainage tank 70 and the water is transferred to the water collecting part along a path ‘h′’.

As shown in FIGS. 5 and 6, the paths h and h′ communicate the water overflow receiving room with the water collecting part 29. The water collecting part 29 may determine a level of the collected water, using a water level sensor 29a provided therein.

Next, the passage of the water among the water drainage tank, water overflow receiving room and water collecting part shown in FIGS. 5 and 6 will be described.

During a normal operation of the laundry treating device, the water collecting part 29 temporarily collects the water contaminated or condensed from the steam along paths ‘b’, ‘i’ and ‘f’ and it drains the water into the water drainage tank 70 along a path ‘g’.

Then, the water drainage tank 70 stores the water drained from the water collecting part 29 until the water level reaches a predetermined value. If the water level reaches the predetermined value, the water drainage tank 70 may not store water any more and the water over the predetermined water level is overflowed into the water overflow receiving room 110, 110b and 110c via the return hole 72.

If it is premised that both the water collecting part 29 and the water drainage tank 70 are emptied at the time when the laundry treating device starts to operate, the water collected in the water collecting part 29 will be drained into the water drainage tank continuously and the water may be stored in the water drainage tank 70 to a predetermined water level, which is determined by the return hole or variation of it.

However, if the water is supplied to the water drainage tank 70 over the predetermined water level, the water which will be drained afterward is overflowed into the water overflow receiving room through the return hole continuously. The water inside the water overflow receiving room may be transferred into the water collecting part 29 again.

If such the process is repeated, the water level of the water collecting part 29 is increased by the water supplied along the path ‘h’, enough to be sensed by the water level sensor provided in the water collecting part 29.

Basically, if sensing water inside, the water collecting part 29 performs the water drainage to the water drainage tank 70 and then the water may not be sensed by the water level sensor 29a anymore because no water will be remaining in the water collecting part 29.

However, if the water is sensed even after having drained the water into the water drainage tank, it means that the water over the predetermined level is re-transferred to the water collecting part 29 from the water drainage tank 70 and accordingly it means that the draining of the water inside the water drainage tank is required.

If it is determined that the water drainage tank 70 needs the water draining in such the process, the control part of the laundry treating machine informs the user that the water drainage tank 70 should be emptied, using the alarming signal.

Then, if the alarming signal alarming the timing point of the draining of the water inside the water drainage tank 70 is generated, it may be controlled to stop the operations of the pump, the control valves controlling paths as well as the laundry treating machine. That is because the condensed or contaminated water is stopped from flowing into the water collecting part 29 before the water inside the water drainage tank is performed.

If the alarming signal is generated, the user separates the water drainage tank 70 and removes the contaminated or condensed water from the water drainage tank 70 and then re-installs the water drainage tank 70.

Once the water drainage tank 70 is re-installed, the drainage pump inside the water collecting part 29 is operated to perform the water draining into the water drainage tank 70.

Hence, the water level of the water collecting part 29 is measured and the user may be provided with an empty requiring signal of the water drainage tank 70 having no water level measuring function.

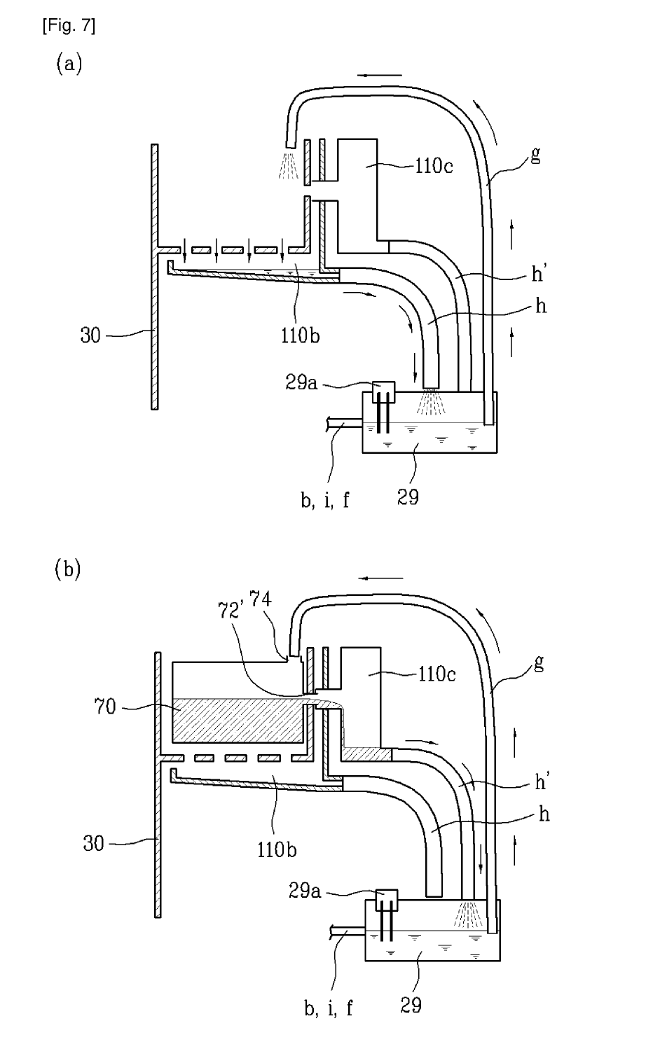

FIG. 7 illustrates other examples of the water drainage tank 70 and the water collecting part 29 according to the laundry treating machine of the exemplary embodiment.

According to FIG. 7, the water overflow receiving room shares those shown in FIGS. 5 and 6. That is, the water overflow receiving room may be configured of the second water overflow receiving room 110b.

The water overflow receiving room includes the second water overflow receiving room 110b provided under the water drainage tank 70 and the water overflow receiving tank 110c. Then, substantially specified control signals may be generated, using the water level sensor 29a provided in the water collecting part 29.

Since the laundry treating machine according to the exemplary embodiment includes the separable water drainage tank, it is difficult to install any water level senses in the water drainage tank 70. Because of that, the water level sensor is provided in the water collecting part 29 inside the mechanism room 20 to supply the water draining signal to the user.

In addition, according to a control method of the laundry treating machine, if the water is overflowed from the water drainage tank 70 and the water overflow receiving rooms are provided under and aside the water drainage tank 70 to receive the overflowed water, the alarming signal may be generated to determined absence of the water drainage tank 70 or whether the water level of the water drainage tank 70 is over the predetermined value.

Next, such the control method of the laundry treating machine will be described.

For example, if the laundry treating machine is put into operation, it is premised that there is no water which will be collected inside the water collecting part 29 and a predetermined amount of water is supplied to the steam generator 25 along the path ‘a’ shown in FIG. 3. The steam generator 25 re-supplies the water to the water collecting part 29 along the path ‘b’. If all the water inside the water collecting part 29 is drained into the water drainage tank, operational states of the laundry treating machine afterward will be specified as follows.

Firstly, it will be one of the operational states that the water drainage tank 70 is installed in the mechanism room 20, with the water level inside the water drainage tank below the predetermined value. Here, the predetermined water level means a maximum water level for the water inside the water drainage tank not to be transferred to the water collecting part 29 via the return hole 72′.

In this case, it means that the water drained into the water drainage tank 70 is not overflowed but stored in the water drainage tank 70. then, it is determined that the water drainage tank 70 is installed and the water inside the water drainage tank needs not emptying and thus the laundry treating machine can be operated normally.

The other cases for the normal operation of the laundry treating machine to be possible may be that the water drainage tank 70 is separated or that the water drainage tank 70 stores water over the predetermined water level although being installed.

In the former case, that is, if the water transferred into the water collecting part from the steam generator 25, in a state of the water drainage tank 70 being separated, the water may be re-transferred to the water collecting part 29 immediately by using the water overflow receiving room 110b provided under the water drainage tank 70.

The water inside the water collecting part 29 is drained by the drainage pump and the timing of the complete water draining inside the water collecting part is sensed by the water level sensor.

Then, the drainage pump is operated until no water level is sensed and from this moment the time period starts to be counted until the water level starts to be sensed inside the water collecting part 29.

That is, a time interval between the drainage time point and the transfer time point is measured. It may be preset that the measurement of the time interval is performed if a power signal of the laundry treating machine is inputted.

If the power signal is inputted, the time interval between the drainage time point and the transfer time point is measured as a primary condition capable of identifying whether a normal laundry treating is possible and the measurement of the time interval may be useable to determine whether the water drainage tank is absent or whether the water inside the water drainage tank reaches the predetermined water level.

In case of the absence of the water drainage tank 70, the time taken to transfer the water to the water collecting part 29 along the path ‘h’ will be measured. in case of the water reaching the predetermined water level inside the water drainage tank 70, the time taken for the water overflowed into the water overflow receiving room to reach the water collecting part along the path ‘h’ will be measured.

For example, in the former case, the time for the water drained into the water drainage tank 70 to be re-transferred to the water collecting part is referenced to as T1 and the time for the water drained into the water drainage tank 70 to be overflowed into the water overflow receiving room and then to be re-transferred to the water collecting part is referenced to as T2. If it senses T1, the control part generates an alarming signal of informing the user that the water drainage tank should be installed. If it senses T2, the control part generates an alarming signal of informing the user that the water drainage tank should be emptied.

T1 of the water transfer time to the water collecting part means that the drained water is immediately transferred along the path ‘h’ and thus T1 is a relatively short time. T2 of the water transfer time to the water collecting part means that the water is transferred to the water collecting part 29 after overflowed into the water overflow receiving room from the water drainage tank 70 and thus T2 is a relatively long time. As a result, T1 and T2 are measured and a difference value between T1 and T2 is preset as Tm.

The control part of the laundry treating machine measures T which is the water transfer time to the water collecting part 29. In case of i) T<Tm, the control part generates the alarming signal of absence of the water drainage tank. In case of ii) T<Tm, the control part generates the alarming signal of alarming the necessity of the water draining from the water drainage tank.

Of course, if the path ‘h’ is substantially longer than the path ‘h′’, the order of the standard value may be changed. That is, in case of i) T>Tm, the alarming signal of the absence is generated. In case of ii) T<Tm, the alarming signal of the necessity of the water draining from the water drainage tank is generated.

If sensing the supplied water, the water collecting part drains the water into the water drainage tank. If the water level inside the water collecting part increasing continuously, the alarming signal informing the user that the water drainage tank is absent or that the water drainage tank needs emptying is generated. Specific measurement of the time interval between the drainage time and the transfer time can identify the absence of the water drainage tank or the necessity of emptying the water drainage tank.

Considering the pipe length of the mechanism room and the measured transfer time, it is determined through which pipe the water is transferred to the water collecting part 29 and the result of this determination may be used to determine whether the water drainage tank is absent or whether the water of the water drainage tank reaches the predetermined water level.

If the time taken for the water drained into the water drainage tank 70 to be retransferred to the water collecting part is referenced to as T1 and the time taken for the water drained into the water drainage tank 70 to be overflowed into the water overflow receiving room and then to be re-transferred to the water collecting part 29 is referenced to as T2, the difference between T1 and T2 could be little and it is difficult to precisely determine whether the water drainage tank is absent or whether the water inside the water drainage tank 70 reaches the predetermined water level.

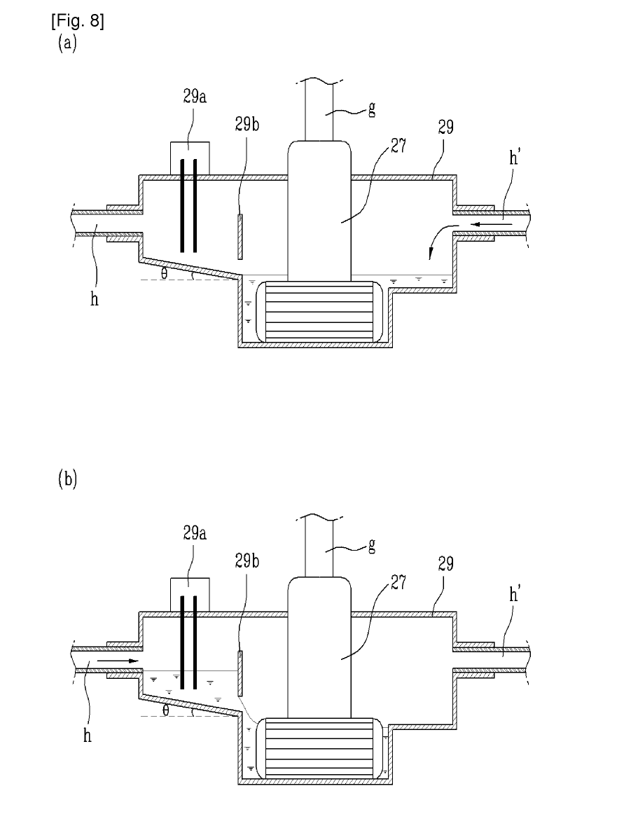

FIG. 8 illustrates an example of the water collecting part 29. as mentioned above, the water collecting part 29 has the path ‘g’ though which the water is transferred thereto from the water overflow receiving room 110b provided under the water drainage tank 70 and the path ‘h′’ through which the water is transferred from the water overflow receiving tank 110c and the path ‘g’ through which the water is re-drained into the water drainage tank 70.

With respect to Tm which is the time difference between T1 and T2 which are the water transfer times into the water collecting part, T which is the transfer time into the water collecting part is measured. In case of i) T<Tm, the alarming signal is generated to inform the user of the absence of the water drainage tank. In case of ii) T>Tm, the alarming signal is generated to inform the user that the water drainage tank needs emptying.

However, there may be T1 and T2 have error ranges, it is necessary to increase the difference between T1 and T2.

Because of that, in case of the absence of the water drainage tank 70, it is preferable the water transfer time is measured immediately. In case of the present of the water drainage tank 70, it is preferable that the water transfer time is measured relatively slowly. For that, the water level sensor 29a may be installed at a connection between the path ‘h’ and the water collecting part 29 and a storage room 29c may be formed at a connection between the path ‘h′’ and the water level sensor 29a to store the water transferred along the path ‘h′’.

As a result, there may be a difference between the times taken to sense the water transferred along the path ‘h’ and the water transferred along the path ‘h′’.

The water transferred along the path ‘h′’ flows into the storage room 29a formed in the water collecting part. After a water level of the storage room 29c is increased, the water is sensed by the water level sensor 29a.

A partition 29b may be provided between the water level sensor 29a and the storage room 29c. Even if the partition 29b partitions off the storage room 29c from the water level sensor 29a, the water can flow between the storage room 29c and the water level sensor 29a. The partition 29b is provided to prevent the water transferred along the path ‘h’ from failing to be sensed by the water level sensor 29a, because the amount of the water transferred along the path ‘h’ is substantially small not enough to be sensed.

According to FIG. 8, the partition 29b may be provided in the housing of the water collecting part 29 and the water transferred along the path ‘h’ may flow under the partition 29b into the storage room 29c.

A lower surface of the water collecting part 29 positioned below the partition 29b may have a predetermined oblique inclined enough for the water transferred along the path ‘h’ to flow into the storage room 29c.

Therefore, even if the separable water drainage tank with no water level sensor is used, it can be determined that the water drainage tank is absent, that is, separated or that the water inside the water drainage tank needs emptying, that is, draining.

If the separable water drainage tank is used to discharge the contaminated or condensed water generated during the laundry treating by supplying the steam or hot air to the laundry, it can be determined that the water drainage tank is separated or that the water of the water drainage tank reaches the predetermined water level.

In reference to FIGS. 1 to 8, according to the laundry treating machine, the water collecting part may be provided to collecting the contaminated or condensed water generated in the laundry treating machine capable of supplying steam to the received laundry and to sense the amount of the collected water. the control method of such the laundry treating machine including the water collecting part includes a draining step draining a predetermined amount of water into a water drainage tank from the water collecting part, the water drainage tank being separable; a water drainage tank state determining step determining whether the water drained in the draining step is transferred to the water collecting part or how long the water transfer takes after the draining; and an alarming step generating an alarm signal according to the information obtained in the water drainage tank state determining step.

That is, the water draining step draining the water inside the water drainage tank is performed and the water drainage tank state determining step is performed. After that, the alarming step enables the user to determine the absence of the water drainage tank or the necessity of the water draining from the water drainage tank, without any auxiliary operations.

In this case, If it is determined that the water is transferred to the water collecting part, it is determined whether the water drainage tank is absent or whether the water inside the water drainage tank reaches a preset water level based on the time taken for the water transfer after the draining as mentioned above.

The drain tank state judging step compares the time taken to transfer the water drained in the draining step into the water collecting part with a preset time, to determine that the water drainage tank is absent if the time is shorter than the preset time and to determine that the water inside the water drainage tank reaches the preset water level if the time is longer than the preset time.

The alarming step generates a signal identifying that the water drainage tank is absent or the water level inside the drain tank reaches the preset value.

It will be apparent to those skilled in the art that various modifications and variations can be made in the present invention without departing from the spirit or scope of the invention. Thus, it is intended that the present invention cover the modifications and variations of this invention provided they come within the scope of the appended claims and their equivalents.

1. A laundry treating machine comprising:
a receiving room receiving laundry;
a steam generator supplying steam to the receiving room;
a circulation duct circulating air inside the receiving room;
a water collecting part collecting water remaining or condensed from steam in the steam generator, the water collecting part capable of sensing a level of the collected water; and
a water drainage tank receiving the water collected in the water collecting part and transferring the water received over a predetermined water level back to the water collecting part, the water drainage tank being separable.

2. The laundry treating machine according to claim 1, wherein the water received in the water drainage tank over a predetermined water level is transferred to the water collecting part through a return hole formed on the water drainage tank.

3. The laundry treating machine according to claim 2, wherein a water overflow receiving room temporarily receiving the water transferred to the water collecting part is provided between the water drainage tank and the water collecting part.

4. The laundry treating machine according to claim 3, wherein the water overflow receiving room is provided under the water drainage tank.

5. The laundry treating machine according to claim 4, further comprising:
a water overflow receiving room configured of a separate water receiving tank receiving water overflowed through the return hole.

6. The laundry treating machine according to claim 2, wherein the return hole of the water drainage tank is formed on a side of the water drainage tank.

7. The laundry treating machine according to claim 5, wherein the water collecting part comprises a water level sensor sensing a water level based on whether an electric current is applied to electrodes installed therein and a drainage pump draining the water inside the water collecting part into the water drainage tank.

8. The laundry treating machine according to claim 7, wherein the drainage pump drains the water inside the water collecting part into the water drainage tank and the water level sensor senses the water transferred to the water drainage tank from the water collecting part to measure a time interval between the drainage time point and the transfer time point.

9. The laundry treating machine according to claim 8, wherein an alarm signal alarming absence of the water drainage tank or alarming necessity of water draining of the water drainage tank is generated, corresponding to the time interval.

10. The laundry treating machine according to claim 8, wherein the measuring the time interval is performed if a power signal of the laundry treating machine is inputted.

11. The laundry treating machine according to claim 1, wherein the water inside the water collecting part is transferred to the water drainage tank if it is sensed that water flow into the water collecting part, and an alarm signal alarming the necessity of the water draining of the water drainage tank if the water level inside the water collection part is continuously increased.

12. A control method of a laundry treating machine comprising a water collecting part collecting water remaining or condensed from steam generated to treat laundry, the water collecting part capable of sensing a level of the collected water, the control method comprising:
a draining step draining a predetermined amount of water into a water drainage tank from the water collecting part, the water drainage tank being separable;
a water drainage tank state determining step determining whether the water drained in the draining step is transferred to the water collecting part or how long the water transfer takes after the draining; and
an alarming step generating an alarm signal according to the information obtained in the water drainage tank state determining step.

13. The control method of the laundry treating machine according to claim 12, wherein if it is determined that the water is transferred to the water collecting part, it is determined whether the water drainage tank is absent or whether the water inside the water drainage tank reaches a preset water level based on the time taken for the water transfer after the draining.

14. The control method of the laundry treating machine according to claim 13, wherein the drain tank state judging step compares the time taken to transfer the water drained in the draining step into the water collecting part with a preset time, to determine that the water drainage tank is absent if the time is shorter than the preset time and to determine that the water inside the water drainage tank reaches the preset water level if the time is longer than the preset time.

15. The control method of the laundry treating machine according to claim 14, wherein the alarming step generates a signal identifying that the water drainage tank is absent or the water level inside the drain tank reaches the preset value.
